(19) United States
(12) Patent Application Publication
(10) Pub. No.: US 2010/0125894 A1
(43) Pub. Date: May 20, 2010

(54) SYSTEMS, METHODS AND COMPUTER PROGRAM PRODUCTS THAT FACILITATE REMOTE ACCESS OF DEVICES IN A SUBSCRIBER NETWORK

(75) Inventors: Mehrad Yasrebi, Austin, TX (US); James Jackson, Austin, TX (US); Bernard Ku, Austin, TX (US)

Correspondence Address: AT&T Legal Department - MB;Attn: Patent Docketing, Room 2A-207, One AT&T Way, Bedminster, NJ, 07921, US

(73) Assignee: AT&T Intellectual Property I, L.P.

(21) Appl. No.: 12/273,577

(22) Filed: Nov. 19, 2008

(51) Int. Cl. H04L 9/32

(52) U.S. Cl. 726/4

(57) ABSTRACT

Systems, methods and computer program products facilitate remote access to devices in a private subscriber network by subscriber-selected delegates. A request is received by a service provider from a delegate to access one or more devices in a private subscriber network. The service provider verifies whether the delegate is authorized by the subscriber to access the device, and displays device access information to the delegate in accordance with an access policy established for the delegate by the subscriber. The device access information includes an address to a web server associated with each device. The web server address comprises an IP address for the subscriber network and a port number associated with each device. The device access information includes login information for the device web server, such as a user ID and password, or SSO token.

### BACKGROUND

The present application relates generally to communications networks, and more particularly, to system, methods and computer program products for accessing devices connected to communications networks.

Communications networks are widely used for nationwide and worldwide communication of voice, multimedia and/or data. As used herein, communications networks include public communications networks, such as the Public Switched Telephone Network (PSTN), terrestrial and/or satellite cellular networks and/or the Internet.

The Internet is a decentralized network of computers that can communicate with one another via Internet Protocol (IP). The Internet includes the world wide web (web) service facility, which is a client/server-based facility that includes a large number of servers (computers connected to the Internet) on which web pages, applications and/or files reside, as well as clients (web browsers), which interface users with the remote servers. Specifically, web browsers and software applications send a request over the web to a server, requesting a web page identified by a Uniform Resource Locator (URL), which notes both the server where the web page resides and the file or files on that server which make up the web page. The request includes the IP address of the client. The server then sends a copy of the requested file(s) to the IP address associated with the client, and the web browser at the client terminal displays the web page to the user. Other types of interaction are possible. For example, a file can be requested from a remote file server, data can be requested from an application on a remote server, etc. In any such exchange, the remote server must be supplied with an address to which the response should be sent.

The topology of the web can be described as a network of networks, with providers of network services called Network Service Providers, or NSPs, or Internet Service Providers (ISPs). As used herein, the term Service Provider (SP) is intended to include NSPs and ISPs. Servers that provide application-layer services may be referred to as Application Service Providers (ASPs). Sometimes a single service provider provides both functions.

FIG. 1 illustrates a private subscriber network 12 (e.g., a home network, office network, etc.) that includes a plurality of web-enabled or smart devices attached thereto. The illustrated web-enabled devices include a security camera 30, a smart refrigerator 40, remotely-activatable door locks 50 and a sprinkler system 60. Each of these devices includes a web server (also called web application server) or is otherwise associated with a web server (web application server) that is configured to serve a web interface to a requesting client through which operation and/or configuration of the device can be controlled and/or performed. The terms “device web server”, “device web application server”, and “device application server” may be used interchangeably to refer to the server that is used to interact with the device. The private network 12 is linked to a communications network 10, such as the Internet, via a residential gateway 20 or other similar device. As one skilled in the art would understand, residential gateway 20 includes a modem (e.g., cable modem, DSL modem, etc.) for accessing the communications network 10. Residential gateway 20 also incorporates router and port forwarding functions. The subscriber “subscribes” connection services from a service provider (SP) that controls the communications network 10 (i.e., the subscriber pays the SP to connect to the communications network 10). The residential gateway has a public address such as 144.16.130.104 for interworking with the communications network 10 and a private address such as 192.1681.1 for communicating to the devices on the private network 12. The residential gateway implement port mapping (also called port forwarding) functions such as a port “po” of its public address is mapped onto a port “pi” of a device on its private network. For example, as shown in FIG. 1, the residential gateway 20 maps address 144.16.130.104:7803 to 192.168.1.1:80 and supports only the secure http (https) on its 144.16.130.104:7803 address,

A user desiring to remotely access a network device (30, 40, 50, 60), e.g., via a client device connected to the Internet 10, must know the IP address of the device and then whatever authentication criteria that is required by the device. User authentication is commonly performed via the use of login credentials, such as user IDs and passwords. In addition, more stringent authentication processes may be utilized, such as the use of digital certificates that are issued and verified by a certificate authority.

Most networked devices have their own specific authentication mechanisms and access controls. As such, controls are typically different for each device, although many such different devices may belong to a given entity (e.g., a single subscriber). Such controls often differ in the degrees of features and security mechanism that they support. In addition, network addresses of such devices may change over time (e.g., using dynamic IP and/or port addresses). As such, access to web-enabled devices on a subscriber network typically requires knowledge of IP addresses and the unique authentication requirements for each device.

### SUMMARY

According to exemplary embodiments, systems, methods, and computer program products are provided that facilitate remote access to devices in a private subscriber network by subscriber-selected delegates. According to some embodiments, a method of facilitating remote access to devices in a private subscriber network by subscriber-selected delegates includes the following steps performed by a communications network SP: receiving a request from a delegate to access a device in the subscriber network; verifying that the delegate is authorized by the subscriber to access the device; and displaying device access information to the delegate in accordance with an access policy established for the delegate by the subscriber. Verifying that the delegate is authorized by the subscriber includes receiving login information from the delegate, and verifying that the received login information is associated with the subscriber. The device access information includes an address to a web server associated with the device. The address is activatable by the delegate via a client, and the device is accessed by the delegate through a connection established between the client and the device web server via the SP network. The web server address comprises an IP address for the subscriber network and a port number associated with the device. The IP address is provided by the SP and may be a static or dynamic IP address. In some embodiments, the device access information includes login information for the device web server, such as a user ID and password.

In some embodiments, the subscriber network device includes the device web server. In other embodiments, the device web server is remotely located with respect to the device. For example, the device web server may be a web server of a manufacturer of the device, and the provided address includes an IP address for the manufacturer web server and a unique identifier for the device. In other embodiments, the address may include a single sign-on (SSO) token. The manufacturer/device web server receives the SSO token when a connection is established between the client and the manufacturer/device web server. The manufacturer web server communicates the SSO token to the SP to verify that the delegate is authorized to access the manufacturer/device web server.

According to embodiments, a communications network SP remote network device management system that facilitates remote access to devices in a private subscriber network by subscriber-selected delegates includes an application server configured to receive a request from a delegate to access a device in the subscriber network; an authentication server configured to verify that the delegate is authorized by the subscriber to access the device; and a policy server configured to provide device access information to the delegate, via the application server, in accordance with an access policy established for the delegate by the subscriber.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which form a part of the specification, illustrate some exemplary embodiments. The drawings and description together serve to fully explain the exemplary embodiments.

FIG. 1 is a block diagram that illustrates a home subscriber network of a telecommunications network subscriber, and wherein the home network includes a plurality of web-enabled devices.

FIG. 2 is a block diagram that illustrates systems, methods, and computer program products that facilitate remote management of one or more web-enabled devices in a network of a telecommunications network subscriber, according to some embodiments.

FIG. 3 is a block diagram of a telecommunications network service provider remote device management system, according to some embodiments.

FIGS. 4-5 are flow charts of operations that allow subscribers to provision device access and control rights to delegates, according to some embodiments.

FIGS. 6-10 are flow charts of operations for remote access and management of web-enabled devices in a network by a delegate, according to some embodiments.

FIG. 11 is a block diagram that illustrates details of an exemplary processor and memory that may be used by a service provider remote device management system, according to some embodiments.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification are taken to specify the presence of stated features, steps, operations, elements, and/or components, but do not preclude the presence or addition of one or more other features, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items and may be abbreviated as

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the terms “IP address” and “universal resource locator” (URL) are interchangeable and are defined to mean the unique address for a file or device that is accessible via the Internet.

It will be understood that, although the terms first, second, etc. may be used herein to describe various elements, these elements should not be limited by these terms. These terms are only used to distinguish one element from another.

Exemplary embodiments are described below with reference to block diagrams and/or flowchart illustrations of methods, apparatus (systems and/or devices) and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments may be implemented in hardware and/or in software (including firmware, resident software, micro-code, etc.). Furthermore, exemplary embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Python, Java, AJAX (Asynchronous JavaScript), C, and/or C++, for development convenience. In addition, computer program code for carrying out operations of exemplary embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

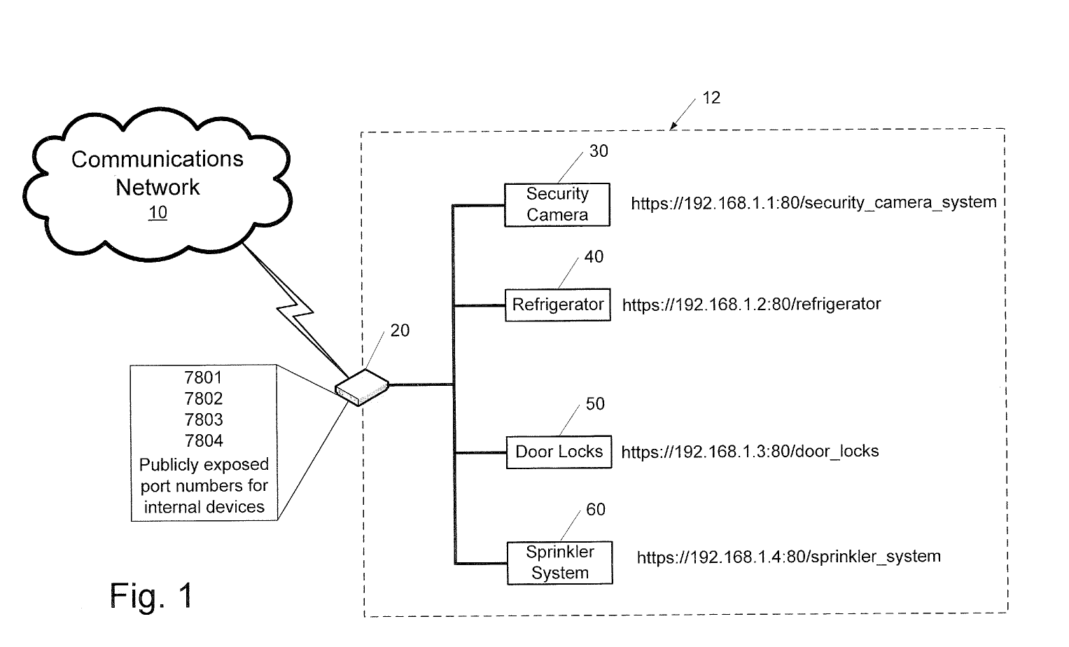

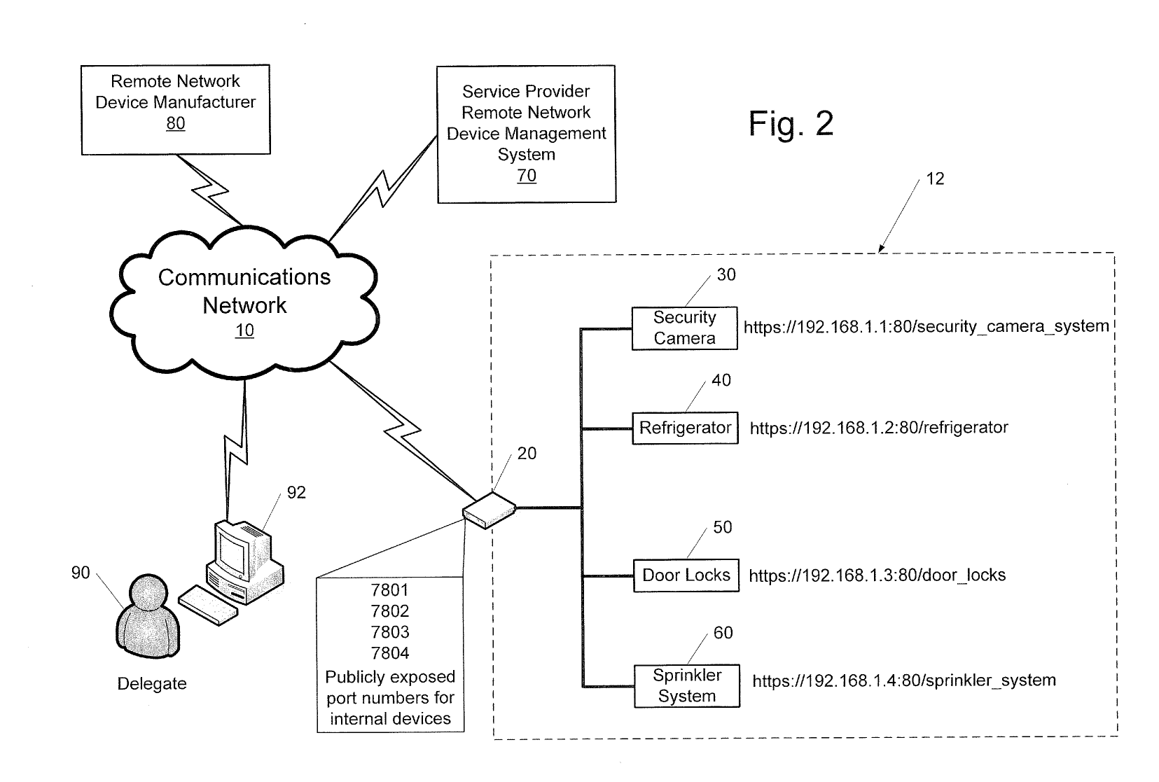

FIG. 2 illustrates systems, methods, and computer program products that facilitate remote access and management of one or more web-enabled devices in a private subscriber network, such as the private subscriber network 12 of FIG. 1, according to some embodiments. As described above, the illustrated private network 12 includes a plurality of intelligent devices: a web-enabled security camera 30, a web-enabled refrigerator 40, a web-enabled remotely-activatable door lock 50 and a web-enabled sprinker system 60. Each of these devices includes a web server or is otherwise associated with a web server that is configured to serve a web interface to a requesting client through which operation and/or configuration of the device can be controlled and/or performed remotely.

In some instances, it may be desirable for the owner of a private network to allow one or more other people and/or programs to access one or more devices on the private network. As used herein, the term “owner” refers to the person or entity that subscribes connection services to the communications network (e.g., Internet, etc.) 10 from a communications network SP. As such, the terms “owner” and “subscriber” are interchangeable.

As used herein, the term “access” includes discovery of the existence of devices on a subscriber network, access to any subsets of subscriber network devices, and management (e.g., configuration, operational control, etc.) of subscriber network devices

As used herein, a subscriber network device includes any type of device a subscriber has connected to a network including, but not limited to, telecommunications residential gateways, remotely-accessible premises camera systems, remotely-controlled door locks, remote-controllable home automation systems, smart appliances, and any type of intelligent device.

Private and automated services for authenticated and authorized access to devices using any global identity are provided. Such devices may have dynamic IP addresses, which are assigned/changed by an SP. As will be described in detail below, any allowed identity of each person/entity is used: a) to control discovery of networked devices owned by that person/entity by his/her authorized delegates, b) to authorize access to any subsets of such devices by such delegates using any desired policy (such as limited time window(s) or scopes for access), and c) to use any trusted authentication schemes (such as, but not limited to, digital certificates, biometrics, etc.) to authenticate persons/entities claiming to be such delegates.

The communications network 10 may operate using a communications protocol such as TCP/IP, and may, for example, be the Internet. It will be appreciated, however, that the communications network 10 can include any public and/or data communications network, and can operate using any communication protocol. The communications network 10 may represent a global network, such as the Internet, or other publicly accessible network. The communications network 10 may also, however, represent a wide area network, a local area network, an Intranet, or other private network, which may not be accessible by the general public. Furthermore, the communications network 10 may represent a combination of one or more wired and/or wireless public and/or private networks and/or virtual private networks (VPN).

As will be described herein, a subscriber can grant others, referred to as “delegates” 90, the right to access one or more devices on a private network 12 via a client device 92 connected to the communications network 10 (e.g., via a cable, DSL, dial-up and/or wireless connection). For example, the subscriber of the illustrated network 12 may grant a delegate 90, such as a neighbor, the right to remotely access and configure the sprinkler system 60 in case of an emergency or malfunction (e.g., if the sprinkler system will not shut off, if the sprinkler system is operating at the wrong time, etc.). As another example, a subscriber may grant a delegate 90, such as a home security company, the right to remotely access and configure the security camera 30 (e.g., to readjust the position of the camera, to reset the camera, to download images from the camera, etc.).

In the illustrated network 12 of FIG. 2, the residential gateway 20 has an IP address (e.g., a static IP address or a dynamic IP address assigned by the communications network SP) and each network device has a respective IP address, as illustrated. Each network device (30, 40, 50, 60) also includes a respective web server or is otherwise associated with a web server (e.g., a manufacturer's web server) that is configured to serve a web interface to a client that sends a request to the respective device IP address.

The subscriber of the private network 12 identifies delegates that can access one or more of the network devices (30, 40, 50, 60) and provisions rights (i.e., creates network device access policies) for identified delegates via the SP remote network device management system 70. Communications network 10 and remote network device management system 70 need not be provided by the same SP, but are shown as such for conciseness. Provisioned rights include, but are not limited to, an identification of what devices a delegate has access to, what devices a delegate does not have access to (e.g., by the virtue of omission in configuration data), and what actions a delegate can perform regarding a particular device. In addition to identifying delegates and listing network devices that identified delegates can and cannot access, a subscriber also uses the SP remote network device management system 70 to provide delegate authentication schemes (e.g., user IDs, passwords, digital certificates, etc.), and device characteristics including, but not limited to IP addresses, SSO links, and the like.

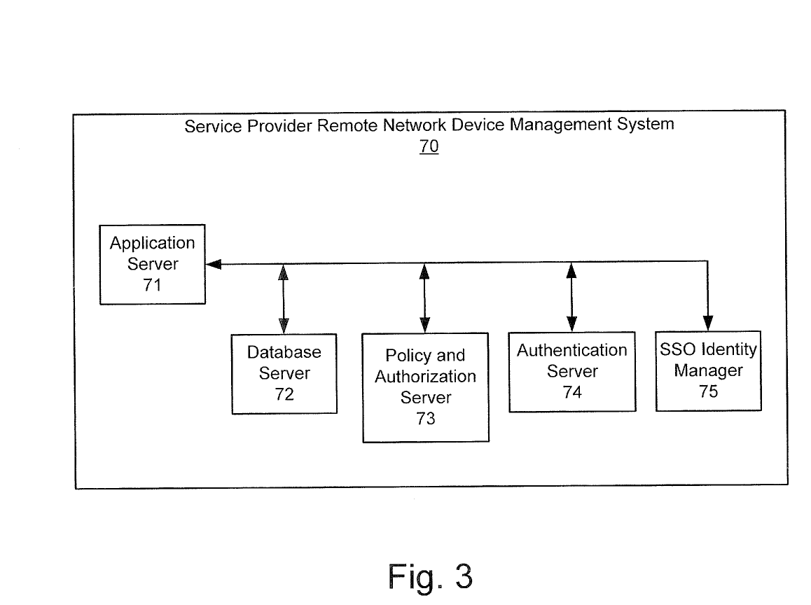

In the illustrated embodiment of FIG. 3, the SP remote network device management system 70 includes an application server 71, a database server 72, a policy and authorization server 73, an authentication server 74 and an SSO (Single Sign-On) identity manager 75. A subscriber communicates with the application server 71 to designate delegates and to provision rights to the delegates. The subscriber's delegates (or persons claiming to be delegates) communicate with the application server 71 to authenticate themselves and to access network devices for which they have been granted access. The application server communicates with the database server 72, policy and authorization server 73, authentication server 74 and SSO identity manager 75 to carry out the various subscriber and delegate functions described below. The application server 71 is also configured to communicate with an SP network device having knowledge of static/dynamic IP addresses of subscribers (not shown).

The database server 72 is configured to store and retrieve records and policies associated with subscribers and delegates from one or more databases. As is known by those of skill in the art, a database is a collection of data that is organized in “tables.” A database typically includes a database manager that facilitates accessing, managing, and updating data within the various tables of a database. Exemplary types of databases that can be used for storing subscriber and delegate records and policies, according to embodiments, include, but are not limited to, relational databases, distributed databases (databases that are dispersed or replicated among different points in a network), and object-oriented databases. Relational, distributed, and object-oriented databases are well understood by those of skill in the art and need not be discussed further herein. Exemplary commercial databases that can be used in accordance with embodiments include, but are not limited to, IBM's DB2® database, Microsoft's SQL server database, and other database products, such as those from Oracle, Sybase, and Computer Associates.

The policy and authorization server 73 is configured to allow a subscriber to set one or more network device access policies for delegates. A device access policy is a formal set of statements that identify which delegates have access to which network devices (e.g., 30, 40, 50, 60), and what rights these delegates have with respect to the network devices. Policies can allocate based on time of day, delegate priorities, availability of devices, and other factors. Policies can also have a limited time window in which they are in effect. The policy and authorization server 73 allows a subscriber to modify policies and to retrieve audit data associated with delegate access of network devices, among other functions.

The authentication server 74 is configured to authenticate delegates (or persons claiming to be delegates) prior to allowing access to network devices. The authentication server 74 verifies that a purported delegate is in fact authorized to access a particular network and one or more devices on the network. The SSO identity manager 75 is configured to allow single sign-on procedures for delegates such that authentication is required only once to access multiple devices on a network. Operations by the SSO identity manager 75 are described below.

An SP remote network device management system 70, according to embodiments, is not limited to the illustrated components. Various components may be utilized and one or more components may perform the functions of other components.

### Subscriber Provisioning of Delegate Rights

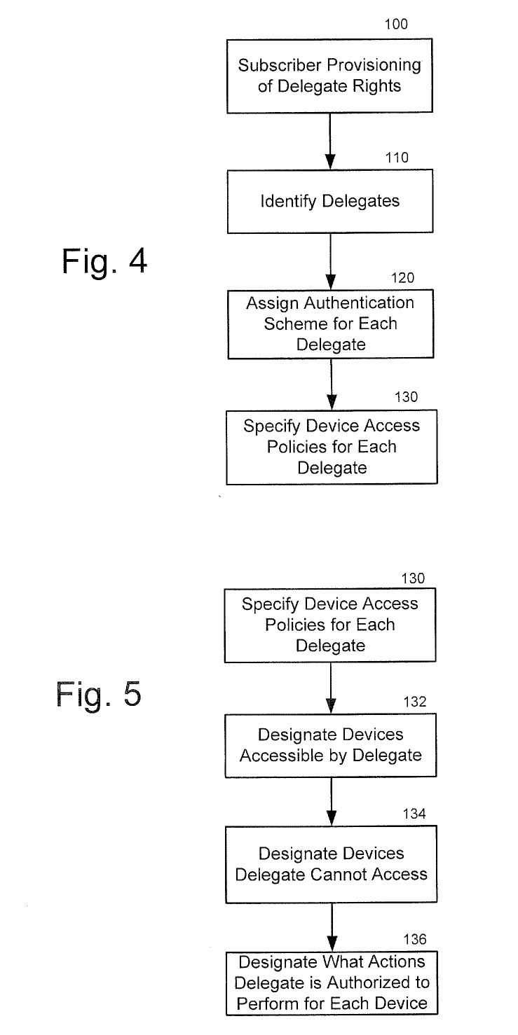

Operations for identifying delegates and provisioning rights to delegates are described with respect to FIGS. 4-5. Referring initially to FIG. 4, the provisioning of rights to delegates (Block 100) by a subscriber of a private network (e.g., network 12, FIG. 2) includes identifying delegates (Block 110), assigning authentication schemes to each delegate (Block 120), and specifying device access policies for each delegate (Block 130). The information provided by a subscriber is stored in the various components of the SP remote network device management system 70 described above. For example, delegate information for each subscriber is stored and accessed via the database server 71. Device access policies for each delegate are stored and accessed via the policy and authorization server 72. Authentication schemes including, but not limited to, user IDs, passwords, and digital certificates are stored and accessed via the authentication server 73.

Each network device of a subscriber's network for which the subscriber wants to grant access to a delegate includes an entry within the database server. An exemplary database entry for a network device includes the device name, device protocol, device URL, description field, supplementary information field, and SSO optional hyperlink. The supplementary information field may, at the option of the subscriber, include current user ID and password for each specific device. An SSO optional hyperlink is associated with an SSO mechanism to the interface of the target mapped device. Generation and support of this hyperlink can be assisted by the SP, where the SP and the device manufacturer would have supported the same standardized interface (such as Liberty Alliance's SSO protocol) and the SP ENUM (tElephone NUMbering) service is considered as a trusted domain. If such a hyperlink is provided, then access to the target mapped device would not require another level of authentication.

Referring to FIG. 5, specifying device access policies for each delegate (Block 130) includes designating which network devices the delegate can access (Block 132) and designating which network devices the delegate cannot access (Block 134). Operations represented by Block 134 may be implicit in operations represented by Block 132 by omitting devices that exist in subscriber's home network, but are not to be accessed by delegates. In specifying device access policies for each delegate (Block 130), a subscriber may also designate what actions a delegate is authorized to perform for each network device (Block 136) as supported by the device. For example, with respect to the sprinkler system 60 of FIG. 2, a particular delegate may be given authorization to change the time of day that the sprinkler system 60 turns on and off, among other functions. Another delegate may be given authorization to only turn off the sprinkler system 60 when a malfunction occurs, etc. The ability to provide granular access to specific (subsets of) control functions of the devices depends on capabilities of such devices.

### Delegate Remote Access of Network Devices

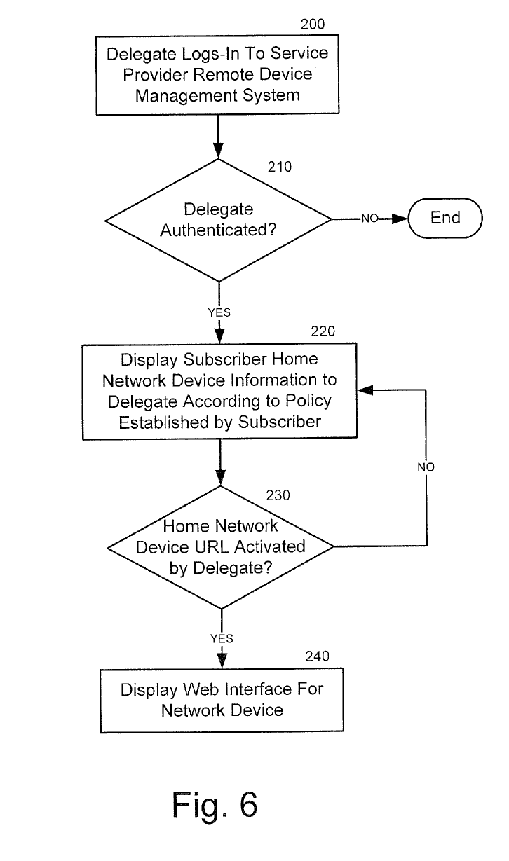

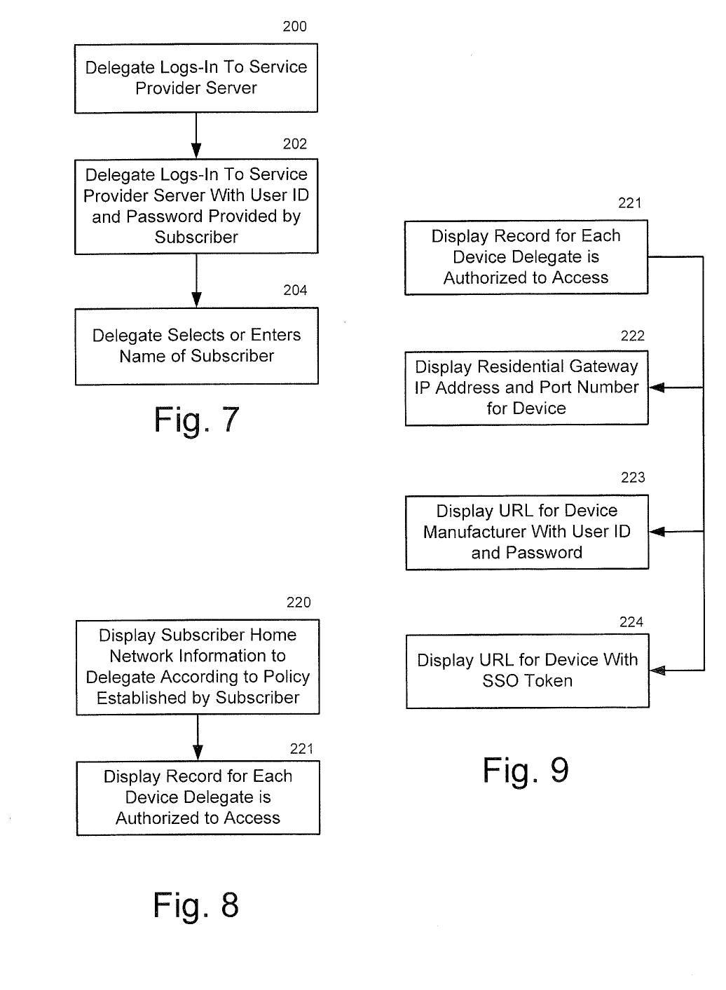

FIGS. 6-10 are flow charts of operations for remote access of web-enabled devices in a network by a delegate, according to some embodiments. Referring initially to FIG. 6, a delegate (or someone claiming to be a delegate) logs in to the SP remote device management system 70 (Block 200) via a client device using a URL such as www.att.com/myhome, for example. The SP remote device management system 70 renders a web page in which the delegate performs one or more login operations to become authenticated. For example, in some embodiments, the delegate enters a user ID and password provided by a subscriber (Block 202, FIG. 7). In some embodiments, the delegate may be required to select or enter the name of a subscriber (Block 204, FIG. 7). If the delegate is not authenticated by the authentication server 74, operations terminate. A record may be created and stored in a log of the non-authentication event.

If the delegate enters a user ID and password, the SP remote device management system 70 identifies the subscriber by associating the user ID and password with a global identity for the subscriber. Exemplary global identities include, but are not limited to, telephone numbers (e.g., an E. 164 telephone number, etc.), social security numbers, street addresses, and the like.

If the delegate is authenticated by the authentication server 74, the SP remote device management system 70 presents the delegate with information about network devices the delegate is authorized to access according to one or more policies established by the subscriber (Block 220). For example, a record for each network device the delegate is authorized to access is displayed (Block 221, FIG. 8). Each network device record provides the delegate with a URL to the web server of the particular network device and provides the delegate with various information about the network device and the functions the delegate is authorized to perform. As illustrated in FIG. 9, the SP remote device management system 70 is configured to present an authenticated delegate with a URL to a web server associated with a network device in various ways. For example, the SP remote device management system 70 can display a URL containing the IP address of the network gateway 20, and the port number for the network device web server (Block 222). In other embodiments, the SP remote device management system 70 can display a URL for a web server of the manufacturer of the network device and can display a user ID and password for use in authentication at the manufacturer web site (Block 223). In yet other embodiments, the SP remote device management system 70 can display a URL for a web server of the network device along with an SSO token for use in automatically authenticating the delegate (Block 224). One or more protocols (such http and secure http (https)) may be used to access the web interface associated with the device. Each of these embodiments are described below.

An exemplary record that is displayed to an authenticated delegate for a network device that the delegate is authorized to access is illustrated in Table 1, below.

TABLE 1

| | |
|---|---|
| Record | 1001 |
| Number | |
| Device | Remote sprinkler system |
| Name | |
| Protocol | HTTPS |
| URL | https://145.69.4.37:7804/emergency-sprinkler-control |
| Description | This is the web interface for shutting down the sprinkler, in |
| | case it does not shut off. It provides only emergency shut- |
| | off access to the valve controls. Please use the following |
| | credentials to log in to the browser window of the sprinkler |
| | system: |
| | User ID = shut_off_delegat |
| | Password = x1Z39HyvcPdS |

In the record illustrated in Table 1, the authenticated delegate is allowed remote access to the sprinkler system 60 in network 12 (FIG. 2). A URL is provided to the web interface for the emergency shut-off control of the sprinkler system and a description of what actions the delegate can take are provided. The URL for the remote sprinkler system includes the IP address of the network gateway 20, the port number (:7804) for the sprinkler system web server, and an address that points to one or more subsets of functions for the sprinkler system. In this embodiment, the gateway IP address is provided by the SP. The port number for the sprinkler system web server and address to one or more subsets of functions is provided by the subscriber during provisioning (i.e., when policies are defined by subscriber for delegate). The remote device management system 70 assembles the gateway IP address, network device port number and web server address into the displayed URL that is presented to the delegate.

As described above, the gateway IP address may be static or dynamic. If the gateway IP address is static, the remote device management system 70 retrieves the IP address from a database associated with the subscriber. If the gateway IP address is dynamic, the remote device management system 70 retrieves the IP address from a SP network address device (not shown) connected to the communications network 10. As such, the SP remote device management system 70 serves as a redirection facility and provides a mapping function between the user ID and password assigned to a subscriber and an IP address of the subscriber's network gateway. The address following the port number for the sprinkler system limits the functions that the delegate can perform via a web interface served by the sprinkler system web server. As such, the subscriber can control and limit what actions the delegate can perform.

Referring back to FIG. 6, if the delegate activates the displayed URL for the device (which in this case is the sprinkler system) (Block 230), a web interface is served by the web server for the network device and displayed to the delegate (Block 240). The delegate then performs one or more operational/management functions of the device via the displayed web interface.

An exemplary record displayed to an authenticated delegate for a network device that the delegate is authorized to access is illustrated in Table 2 below, according to other embodiments.

TABLE 2

| | |
|---|---|
| Record Number | 1002 |
| Device Name | Remote security camera system |
| Protocol | HTTPS |
| URL | https://acme-camera.com/982765134L_123 |
| Description | This is the camera system |
| Supplemental | Please go to the above web site and use the following |
| | credentials to access the camera system: |
| | user ID = jsmain129 |
| | password = Ayt09mbsTYyice |

The illustrated record allows an authenticated delegate to access the security camera 30 of network 12 (FIG. 2). In the record shown in Table 2, the SP remote device management system 70 displays a URL for a web server of the manufacturer (e.g., 80, FIG. 2) of the camera 30 along with a user ID and password for use in accessing the authentication at the manufacturer web site 80. If the delegate activates the displayed URL, a web interface is served from the camera system manufacturer, and is displayed to the delegate. The delegate then enters the user ID and password provided by the subscriber to gain access to the security camera 30 (FIG. 2). The delegate then performs one or more operational/management functions of the device via the displayed web interface.

An exemplary record displayed to an authenticated delegate for a network device that the delegate is authorized to access is illustrated in Table 3 below, according to other embodiments.

TABLE 3

| | |
|---|---|
| Record | 1003 |
| Number | |
| Device Name | Remote Door-Lock Control system |
| Protocol | HTTPS |
| URL | https://145.69.4.37:7803/door-lock?sso-token= |
| | A7345490jd8yTRwasP&IdentificatIonMethod=pw |
| Description | This is the web interface for shutting down the sprinkler, |
| | in case it does not shut off. |
| Supplemental | Please click on the URL link, and you would not need to |
| | provide any more credentials information. Use the web |
| | interface to lock and unlock the doors to the basement. |

The illustrated record allows an authenticated delegate to access the control mechanism for the door locks 50 in network 12 (FIG. 2). In the record shown in Table 3, the SP remote device management system 70 displays a URL for the web server of network device along with an SSO token (Block 224, FIG. 9). SSO is a session/user authentication process that permits a user to enter one name and password in order to access multiple applications.

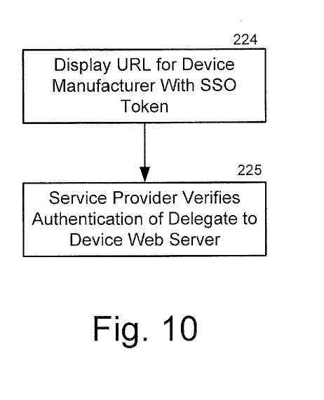

When the delegate activates the displayed URL, the network device web server sends the SSO token to the SSO identity manager 75 of the SP remote device management system 70. The SP SSO identity manager 75 verifies to the remote -control door-lock control system device web (application) server that this particular delegate has already been authenticated is authorized (and, implicitly) is authorized to manipulate the door locks remotely (Block 225, FIG. 10). The SSO process authenticates the delegate for all the applications the delegate has been given rights to and eliminates further prompts when the delegate switches applications during a particular session. As such, the delegate is not required to provide any further authentication information to gain access to the door-lock control system 50.

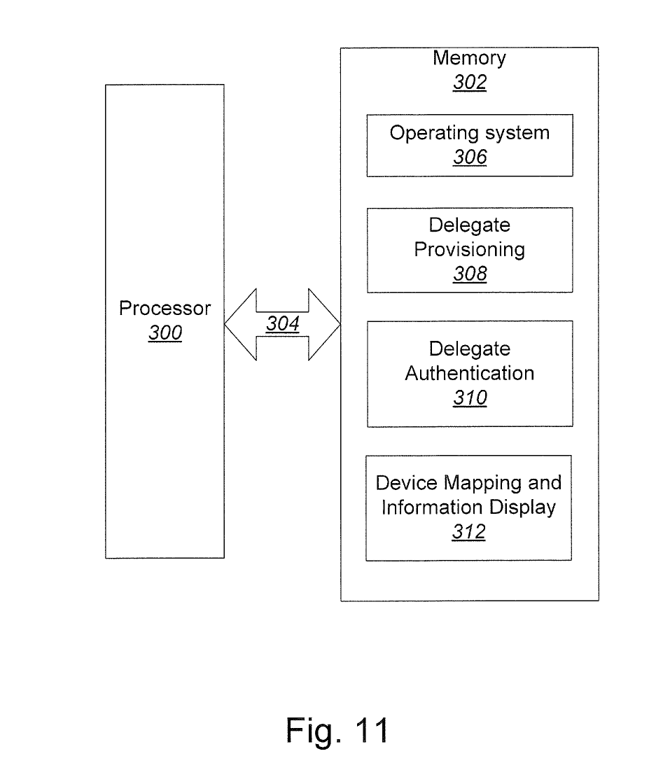

FIG. 11 illustrates an exemplary processor 300 and memory 302 that may be used by an SP remote network device management system 70, according to some embodiments. The processor 300 communicates with the memory 302 via an address/data bus 304. The processor 300 may be, for example, a commercially available or custom microprocessor. The memory 302 is representative of the overall hierarchy of memory devices containing the software and data used to implement a remote network device management system 70 as described herein, in accordance with some embodiments. The memory 302 may include, but is not limited to, the following types of devices: cache, ROM, PROM, EPROM, EEPROM, flash, SRAM, and DRAM.

As shown in FIG. 11, the memory 302 may hold various categories of software and data: an operating system 306, a delegate provisioning module 308, a delegate authentication module 310, and a device mapping and information display module 312. The operating system 306 controls operations of the remote network device management system 70. In particular, the operating system 306 may manage the resources of the remote network device management system 70, and may coordinate execution of various programs (e.g., the delegate provisioning module 308, the delegate authentication module 310, and the device mapping and information display module 312, etc.) by the processor 300.

The delegate provisioning module 308 comprises logic for allowing network subscribers to provision rights to delegates and to specify device access policies for delegates, as described above. The delegate authentication module 310 comprises logic for verifying that a delegate is authorized as a delegate for a particular network subscriber, as described above. The device mapping and information display module 312 comprises logic for displaying network device information to authenticated delegates according to policies established by the network subscriber, as described above.

Many variations and modifications can be made to the exemplary embodiments without substantially departing from the principles of the present invention. All such variations and modifications are intended to be included herein within the scope of the present invention, as set forth in the following claims.

That which is claimed:

1. A method of facilitating remote access to devices in a private subscriber network by at least one subscriber-selected delegate, wherein the private subscriber network is connected to a communications network of a service provider (SP), the method comprising the following steps performed by the SP:
receiving a request from a delegate to access a device in the subscriber network;
verifying that the delegate is authorized by the subscriber to access the device; and
presenting for display device access information to the delegate in accordance with an access policy established for the delegate by the subscriber.

2. The method of claim 1, wherein verifying that the delegate is authorized by the subscriber comprises:
receiving login information from the delegate; and
verifying that the received login information is associated with the subscriber.

3. The method of claim 1, wherein the device access information includes an address to a web server associated with the device, wherein the address is activatable by the delegate via a client, and wherein the device can be accessed by the delegate through a connection established between the client and the device web server via the SP network.

4. The method of claim 3, wherein the web server address comprises an Internet Protocol (IP) address for the subscriber network and a port number associated with the device.

5. The method of claim 4, wherein the IP address is provided by the SP.

6. The method of claim 3, wherein the device access information includes login information for the device web server.

7. The method of claim 6, wherein the device web server login information includes a user ID and password.

8. The method of claim 3, wherein the device comprises the device web server.

9. The method of claim 3, wherein the device web server is remotely located with respect to the device.

10. The method of claim 9, wherein the device web server is a web server of a manufacturer of the device.

11. The method of claim 10, wherein the address includes an Internet Protocol (IP) address for the manufacturer web server and a unique identifier for the device.

12. The method of claim 3, wherein the address includes a single sign-on (SSO) token, wherein the device web server receives the SSO token when a connection is established between the client and the device web server, and wherein the device web server communicates the SSO token to the SP to verify that the delegate is authorized to access the device web server.

13. A communications network service provider (SP) remote network device management system that facilitates remote access to devices in a private subscriber network by subscriber-selected delegates, wherein the private subscriber network is connected to the SP communications network, the system comprising:
an application server configured to receive a request from a delegate to access a device in the subscriber network;
an authentication server configured to verify that the delegate is authorized by the subscriber to access the device; and
a policy server configured to provide device access information to the delegate, via the application server, in accordance with an access policy established for the delegate by the subscriber.

14. The system of claim 13, wherein the authentication server is configured to receive login information from the delegate, and verify that the received login information is associated with the subscriber.

15. The system of claim 13, wherein the device access information includes an address to a web server associated with the device, wherein the address is activatable by the delegate via a client, and wherein the device can be accessed by the delegate through a connection established between the client and the device web server via the SP network.

16. The system of claim 15, wherein the web server address comprises an Internet Protocol (IP) address for the subscriber network and a port number associated with the device.

17. The system of claim 16, wherein the IP address is provided by the SP.

18. The system of claim 15, wherein the device access information includes login information for the device web server.

19. The system of claim 18, wherein the device web server login information includes a token to indicate a delegate who has been pre-authenticated.

20. A computer program product for facilitating remote access to devices in a private subscriber network by subscriber-selected delegates, wherein the private subscriber network is connected to a communications network of a service provider (SP), comprising a computer readable storage medium having encoded thereon instructions that, when executed on a computer, cause the computer to perform the following steps:
receive a request from a delegate to access a device in the subscriber network;
verify that the delegate is authorized by the subscriber to access the device; and
presenting for display device access information to the delegate in accordance with an access policy established for the delegate by the subscriber.
